(19) United States
(12) Patent Application Publication
(10) Pub. No.: US 2011/0285535 A1
(43) Pub. Date: Nov. 24, 2011

(54) Mobile Asset Security and Tracking System and Method

(76) Inventor: Clive Barwin, Temecula, CA (US)

(21) Appl. No.: 13/111,886

(22) Filed: May 19, 2011

Related U.S. Application Data
(60) Provisional application No. 61/346,426, filed on May 19, 2010.

(51) Int. Cl. G08B 13/14

(52) U.S. Cl. 340/572.1

(57) ABSTRACT

A mobile asset security, tracking and recovery system and method are disclosed. One or more radio frequency identification (RFID) tags each include an attachment mechanism for attaching to the mobile asset, and having a unique identifier that is continuously transmitted as a radio frequency signal upon activation. A server system receives, via a communications network, registration data from a client system, the registration data including at least description data describing the mobile asset and the unique identifier for each RFID tag attached to the mobile asset, the server system further generating a report of the mobile asset being lost or stolen, the report having at least the unique identifier for each RFID tag attached to the mobile asset. A detection unit receives, via the communications network, the report from the server system, the detection unit having an RFID sensor to sense for the radio frequency signal transmitted by activated RFID tags attached to the mobile asset within a geographical range of the radio frequency signal transmission.

### CROSS REFERENCE TO RELATED APPLICATIONS

This application claims the benefit of priority under 35 U.S.C. §119 to U.S. Provisional Patent Application Ser. No. 61/346,426, filed on May 19, 2010, entitled, “MOBILE ASSET SECURITY AND TRACKING SYSTEM AND METHOD”, the entire disclosures of which is incorporated by reference herein.

### BACKGROUND

This disclosure relates generally to a mobile asset security and tracking system and method, and more particularly a wireless tracking system for recovery of mobile assets that are reported as being lost or stolen.

Mobile assets that can be lost or stolen often have no or insufficient mechanisms for locating and recovering those assets. Where a location and recovery system might be in place, for example with automobiles, such systems are expensive to purchase and install in the automobile and in some cases costly to maintain. The economic benefits of such systems, for locating and recovering the asset for example, sometimes are not justified by the costs to implement such systems, especially when the asset is of a lower value.

What is needed is a system and method for economically tagging an asset, and for reporting, locating, and recovering that asset efficiently when the asset is lost or stolen.

### SUMMARY

In general, this document discusses a system and method for tagging, reporting, tracking and recovering mobile assets. A web based tracking system is disclosed to tag mobile assets for tracking such as cars, motor cycles, devices such as electronics, bicycles, etc., and persons such as children and people suffering from for example Alzheimer's disease. The tagged mobile assets can be reported as missing or stolen, and then tracked for locating and recovery.

This document further discloses a web-based application and client/server architecture for enabling a user to register any number of mobile assets to be tagged, identified and representatively stored as data objects in a central database. The web-based application further receives reports from the owner of the mobile asset of missing or stolen mobile assets, and accesses the related mobile asset data objects stored in the central database, extract's certain data of the asset that is stored in the database, and transmits the selected data of the reporting object to a detection unit (i.e. an RFID tag tracker, or hereinafter simply “tracker”). The detection unit can be a device that is installed in a fixed location, or a mobile device that is installed in a mobile vehicle such as a police car, delivery truck, etc. The data is then stored in a local database in the detection unit, and is used in recovering the reported stolen or missing mobile asset.

In one aspect, a mobile asset security, tracking and recovery method is presented. The method includes receiving, by one or more processors associated with a database, registration data for the mobile asset. The registration data includes description data describing the mobile asset and a tag identifier for a radio frequency tag associated with the mobile asset. The method further includes storing the registration data in the database. The method further includes receiving, by the one or more processors, report data via a communication network indicating the mobile asset is lost or stolen. The report data includes the description data. The method further includes mapping, by the one more processors, the description data and user data to the tag identifier for the radio frequency tag associated with the mobile asset. The method further includes generating, at the one or more processors, a report of the mobile asset being lost or stolen, the report having at least the tag identifier for the radio frequency tag associated with the mobile asset.

In another aspect, a mobile asset security, tracking and recovery system is presented. The system includes a user terminal for receiving registration data for the mobile asset, the registration data including at least description data describing the mobile asset and a tag identifier for a radio frequency tag associated with the mobile asset. The system further includes a server that receives the registration data from the user terminal and stores the registration data in a database, the server receiving report data via a communication network indicating the mobile asset is lost or stolen, the report data including at least the description data, the server mapping the description data and user data to the tag identifier for the radio frequency tag associated with the mobile asset, and generating a report of the mobile asset being lost or stolen, the report having at least the tag identifier for the radio frequency tag associated with the mobile asset.

In yet another aspect, a mobile asset security, tracking and recovery system includes one or more radio frequency identification (RFID) tags. Each RF tag includes an attachment mechanism for attaching to the mobile asset, and has a unique identifier that is continuously transmitted as a radio frequency signal upon activation. The system further includes a server system that receives, via a communications network, registration data from a client system, the registration data including at least description data describing the mobile asset and the unique identifier for each RFID tag attached to the mobile asset, the server system further generating a report of the mobile asset being lost or stolen, the report having at least the unique identifier for each RFID tag attached to the mobile asset. The system further includes a detection unit that receives, via the communications network, the report from the server system, the detection unit having an RFID sensor to sense for the radio frequency signal transmitted by activated RFID tags attached to the mobile asset within a geographical range of the radio frequency signal transmission.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a mobile asset security and tracking system.

FIG. 2 is a block diagram of a mobile asset security and tracking system in accordance with an alternative implementation.

FIG. 3 is a flowchart of a mobile asset security and tracking method.

FIG. 4 is a block diagram of a mobile asset security and tracking system in accordance with an alternative implementation.

Like reference symbols in the various drawings indicate like elements.

### DETAILED DESCRIPTION

This document discloses a web based system and method to tag and register mobile assets, and to enable the reporting of lost or stolen mobile assets for tracking, locating and recovering the mobile assets that are reported as lost or stolen, such as cars, motor cycles, construction equipment, livestock, farm equipment, electronic equipment, children and people suffering from Alzheimer's disease; and other movable assets. A reporting and wireless tracking system to recover the missing mobile assets is further disclosed.

In preferred implementations, the disclosed system and method utilize commercially-available Radio Frequency and data communications networks. Radio Frequency (RF) radiation is a subset of electromagnetic radiation with a wavelength of 100 km to 1 mm, which is a frequency of 3 kHz to 300 GHz, respectively. This range of electromagnetic radiation constitutes the radio spectrum and corresponds to the frequency of alternating current electrical signals used to produce and detect radio waves. RF can refer to electromagnetic oscillations in either electrical circuits or radiation through air and space. Like other subsets of electromagnetic radiation, RF travels at the speed of light.

In order to receive radio signals, for instance from AM/FM radio stations, a radio antenna must be used. However, since the antenna will pick up thousands of radio signals at a time, a radio tuner is necessary to tune in to a particular frequency (or frequency range). This is typically done via a resonator (in its simplest form, a circuit with a capacitor and an inductor). The resonator is configured to resonate at a particular frequency (or frequency band), thus amplifying sine waves at that radio frequency, while ignoring other sine waves. Usually, either the inductor or the capacitor of the resonator is adjustable, allowing the user to change the frequency at which it resonates.

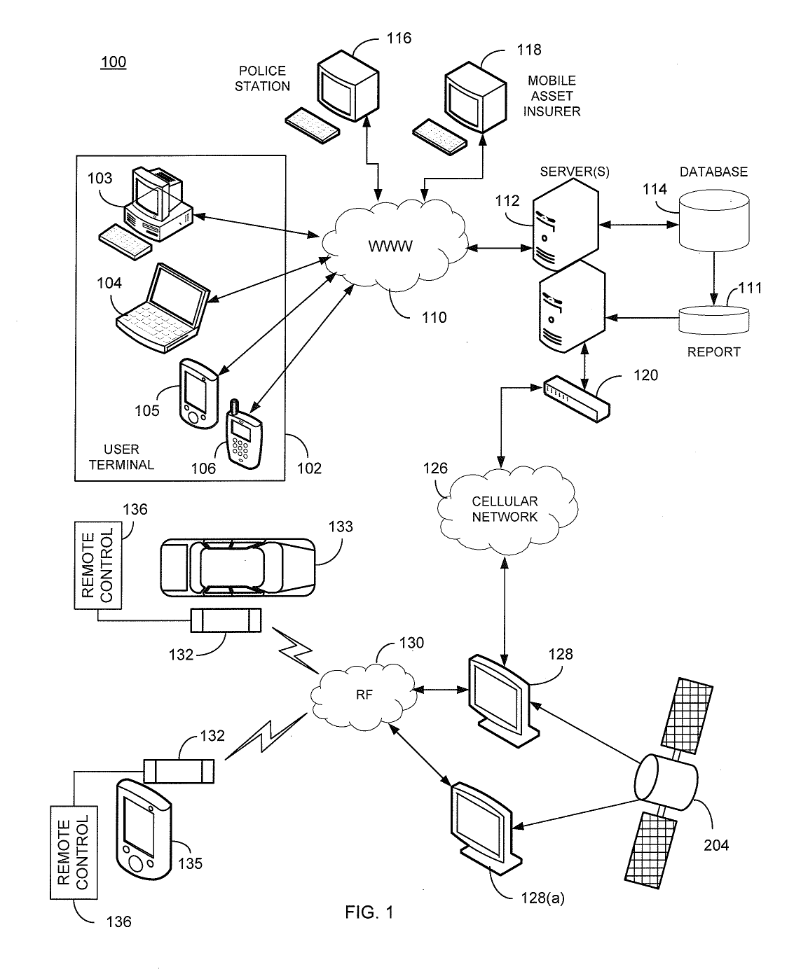

FIG. 1 is a block diagram of a mobile asset security tracking and recovery system 100 in which a user of a user terminal 102 can communicate identification, registration, reporting and management information related to tagged mobile assets to a server system 112 through a network 110 such as the World Wide Web (which represents any number of communication networks that can transmit data according to an Internet Protocol). A user can obtain one or more tags 132. At least one tag 132 can be associated with, i.e. attached to, embedded in, etc., a mobile asset, such as a vehicle or other equipment 133 or electronic device 135. Other mobile assets include people, such as children or impaired adults, animals, bank notes, TVs. In preferred implementations, each tag 132 can be a Radio Frequency Identification (RFID) tag. RFID tags are objects used for tracking of items using radio frequency (RF) signals. An RFID tag is either attached to or embedded in mobile assets of a consumer, or attached to or hidden on a person or animal. Each tag includes a unique identification number.

The users associated with the mobile assets or person register their mobile assets or person, along with the unique RFID number for each tag associated with each mobile asset or person, using an application. The application can be a local application resident on the user terminal 102, or may be a web based application resident on the server system 112 and served through the network 110 to the user terminal 102. The user terminal 102 can be any computing device that can run the application to generate a graphical user interface (GUI) and data input screen. For example, the user terminal 102 can be a desktop computer 103, a laptop computer 104, tablet computer 105, or smart phone 106 or other personal digital assistant (PDA). The GUI generates one or more data input screens that provide input fields for users to input registration and identification data for storing a record of each mobile asset(s) and its associated tag(s) 132.

The information entered in the application generates a record of the mobile asset and its associated tag, and can be encrypted using a private key. The record is transmitted across the packet data network (internet) to the database 114. Alternatively, the registration and identification data is received by the application, which transmits it to a server application on the server system 112, which in turn assembles the data into the record. The database 114 stores the record, including information about the mobile assets or persons and the RFID number corresponding to the mobile asset or person. Various data fields related to different mobile assets for data being gathered and stored by the application are discussed in further detail below.

Once a mobile asset is registered, the server 112 can periodically send updates or status messages to the user terminal for the user, either by email, text message, web messaging, or the like. The messages can include advertisements or official information, such as from the local police or from an insurance company. The messages can inform the user of new products, or new uses of the existing products. In a specific implementation, each tag may be battery operated and have a certain expected lifetime. Once registered, the system 100, via the server 112 or the application on the user terminal 102, can send the user a periodic reminder message about a remaining battery life of the tag, and instructions for the user to obtain a new tag, or to inform the user that the battery may by exhausted and therefore relinquish the ability to track the mobile asset or person if it goes missing.

Registration and identification data, either as raw data or as information provided by a record, can also be transmitted to any of a number of designated authorities, parties such as a local police station 116 or an insurer 118 of the mobile asset. Reports that are made by a user when a mobile asset is missing or stolen can also be routed to the police station 116 and/or insurer 118.

If a registered mobile asset or person goes missing (is lost or stolen), the user via user terminal 102 recalls the asset that was registered in the database and enters additional information pertaining to the missing asset, the database then flags the asset as missing. The application can receive identification data of the mobile asset/person and/or tag, and/or security data related to verified user associated with the mobile asset. A digital signature can be used to trace or check the validity of the person entering the data to ensure that the person entering the data is accountable. Once the asset is flagged as missing, the application creates a record of certain of the data of the missing asset. This record can include, among other information, an image of the mobile asset as provided by the user to the application, other identifying information, e.g. vehicle identification number (VIN) and the tag ID. The data in the form of a report/record can be sent to a public authority such as a terminal and database at the police station 116 or to insurer 118. The server system 112 can send one or more messages (like emails, short message service/text message etc.) to the owner of the asset, police, insurance agencies and other parties who need the information about the loss. The data of the missing assets is also sent to the mobile detection unit and stored in the database of the mobile detection unit (i.e. local database).

In preferred implementations RF tag 132 will continually transmit the serial number or when it comes into the RF range of a detection unit 128 such as an RFID tag tracker. The detection unit 128 can also include a computer and local database. The detection unit 128 will check it's local database to see if the tag id matches. If there is a match, the detection unit 128 will advise a user, i.e. via an interface provided by the detection unit 128, that the asset has been reported as missing and will provide the user with relevant information about the asset. In some implementations, the RF range is from a minimum of 1 ft to a maximum of 10,000 ft. or more. In other implementations, the RF range can exceed 20,000 ft. However, in preferred exemplary implementations, a low-cost RF tag 132 is used, that is simple and easy to attach to a mobile asset by an adhesive such as glue, tape, snap, hook-and-loop fastener, etc., and which has a relatively small geographical range of radio frequency signal transmission.

Once the asset in question comes within the RF range of a detection unit 128, that detection unit128 determines the approximate position of the asset in question relative to its own position. The position of the asset can also be determined relative to other objects. This is done by using triangulation, a method in which, through the use of more than one antenna, the direction of the signal can be ascertained, or by reading and comparing the strength of each directional antenna. As an example if the asset is exactly in an easterly direction of the detection unit 128 then the user of the detection unit 128 will be told that the asset in question is at 3:00 o'clock, or if the asset in question is south of the detection unit 128, then the user of the detection unit 128 will be told that the asset in question is at 6:00 o'clock.

In some instances when the RF tag 132 comes within the RF range of detection unit 128 detection unit 128 will send a signal to the tag 132 to awaken the tag and once awakened the tag will transmit the serial number to the detection unit 128 and go back to sleep for a period of time, it will be awoken when it comes into another detection unit 128 range. This is done to conserve battery consumption of the Tag 132.

In some instances detection unit 128 will be classified as an “active” tracker, and detection unit 128 (a) as a “passive” tracker/detection unit. An active detection unit is a unit that is housed in a police vehicle or private security patrol vehicle. In this instance when a tag in question comes within the range of an active detection unit 128 the details will be displayed on the screen for the user to take action on. The passive detection unit 128 (a) is a unit that is placed in a fixed location, e.g. a busy intersection, a highway or a building, and is not manned by a police officer or a private security person, or in a moving vehicle that is not manned by a police officer or private security patrol vehicle e.g., a delivery vehicle. When a tag in question comes within the range of the passive detection unit 128 (a), the passive detection unit 128 (a) will determine its current position by connecting to a GPS (Global Positioning Satellite) 204, and then connect to the server 112 through the cellular network 126, which sends the Tag ID number and the tag's position to the application running on the server 112. The server 112 will in turn identify the closest one or more active trackers/detection units 128 and send the data (Tag ID number) and co-ordinates of the respective passive detection unit 128 (a) to those identified active detection units 128. Each active detection unit will then display details of the tag in question to a user, and provide the quickest route to the passive detection unit 128(a) using the GPS system 204 and map reading software.

The tag can be equipped with an accelerometer or motion sensor, which will be activated by a remote control device 136, or in some instances by a button in the tag 132. If the mobile asset is lost or stolen while the accelerometer is set, when the tag 132 comes in range of the detection unit 128 or 128(a) the tag will advise the detection unit 128/128(a) of the fact that the motion sensor is set, the detection unit 128 will look for the tag number in the local data first. If no match is found, the detection unit 128 or 128(a) will then call up the database 114 via the cellular network 126 and extract details of the asset tagged using the serial tag ID. The data will be displayed on the detection unit 128 and inform the user that the asset has been moved while the sensor was set and thus could be stolen, or if the Tag with the accelerometer set comes into contact with a passive detection unit 128(a), the passive detection unit 128 (a) will follow the rules set forth above. In this instance/example, the owner might not as yet have reported the asset as lost or stolen.

Once the user of the active detection unit 128 recovers the stolen asset, the recovered date and time is reported on the detection unit 128 by the user of the detection unit 128 and uploaded via the cellular network 126 to the central database 114. The record on both the central database and the local database is updated accordingly. In addition, the local databases of the other detection units will be updated accordingly.

The detection unit 128 can transmit detection data to any end user, such as the user terminal 102, the server system 112, or the police station 116 or insurer 118, via the cellular network 126 connected with the server system 112, for instantaneous reporting and detection of the tags associated with mobile assets. The detection unit 128 may also have real-time reporting capabilities.

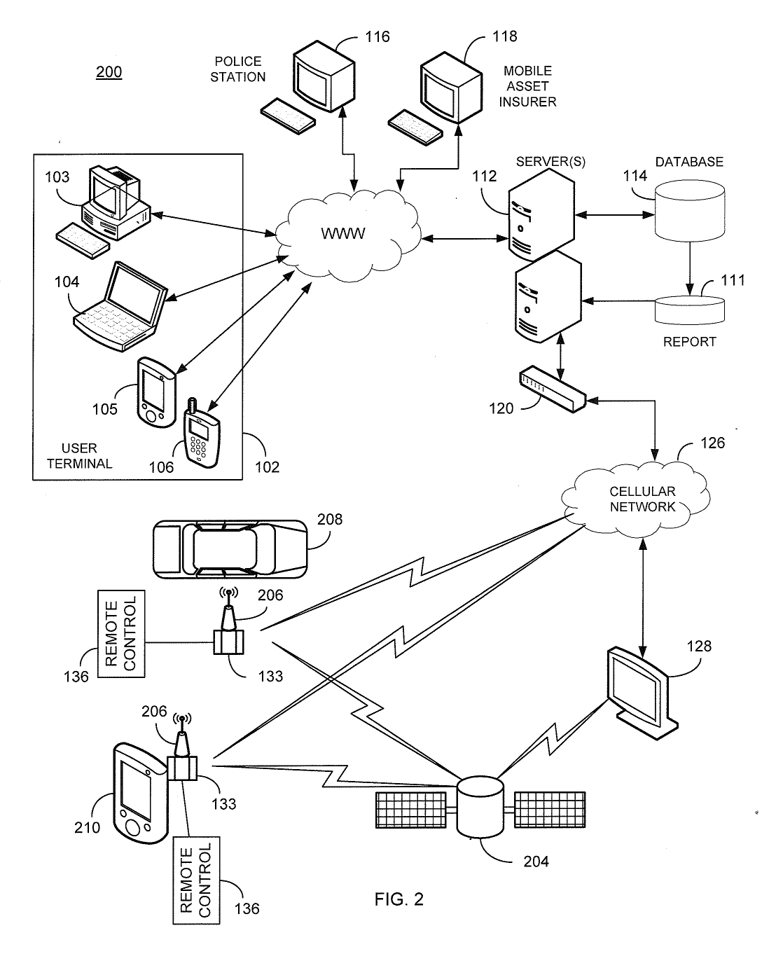

FIG. 2 shows an alternative implementation of a mobile asset security system 200, in which the system 200 utilizes a GPS modem and a cellular modem 206 for detecting GPS data using GPS Satellite 204 associated with each mobile asset 208 or 210 and the cellular network to send the relevant data to the Server 112. The GPS modem and cellular modem 206 can be a standalone unit that is attached to or otherwise affixed to a mobile asset such as an automobile 208. Or, the GPS modem and cellular modem 206 can be pre-installed in the mobile asset such as in a smart phone or other mobile computing or communication device 210. Once a report of a missing mobile asset is made by the user, the relevant GPS/cellular modem 206 can be activated by the Server 112 and can request the GPS geo-location information, once this information is obtained, it is sent to the server. When the server gets the information, the server 112 will determine the nearest mobile active detection unit 128 to the missing mobile asset, send the geo location information to the mobile detection unit which will then allow the mobile detection unit to track and follow the mobile missing asset. In this system 200, therefore, location information need not be searched for or gathered until a report of the missing mobile asset is made.

As an alternative method of tagging, and as shown in FIG. 2, a tag 133 can be a GPS/Cellular modem tag. The tag 133 can have a built-in cellular/GPS wireless processor/modem. This processor will stay dormant or in sleep mode up until the time that the asset that it is tagged to is reported as lost or stolen. Once it is reported stolen the server 112 would update the record in the database 114 as in the preferred mode and create a record for download to the detection unit 128, which will be store as normal in the detection unit 128. In addition, server 112 will communicate directly with the tag 133 and awaken the cellular/GPS wireless processor. Once the wireless processor is awakened, the tag 133 will determine its position using the cellular/GPS network 126. Once the tag's position is determined, the server 112 will continue tracking its exact position and will also call up the cellular/GPS network and determine at least two of the closet in distance active detection unit 128 to the asset reported as stolen. The server 112 will send down instructions to the two selected detection units and advise the user of the detection unit 128 that an asset has been reported as lost or stolen. It will also supply relevant data about the asset. In addition it will provide the user of the detection unit 128 the exact position of the asset now reported as lost or stolen it will also on the display of the detection unit 128 give the user exact directions (mapped and data) from the location of the relevant detection unit 128 to the current up to the second location of the asset reported as lost or stolen.

The main difference between the preferred system and the alternative system is that the stolen asset only can be tracked when a detection unit 128 comes within the RF range which is approximately a maximum of 10,000 ft, whereas in the alternative system the exact location of both the stolen asset and the detection unit 128 can be ascertained, and the system is therefore able to send information to the relevant detection units 128 to enable a user to track and recover the stolen/lost asset, almost immediately after it has been reported lost/stolen by the owner.

The tag 133 can also include an accelerometer, and once set by the owner, if the mobile asset is moved, the tag 133 will automatically call up the server 112 through the cellular/GPS network 126 and report that the asset is moving while in a state that it should be stationary. In this case it will be treated by the system as if the owner reported the asset as stolen, and the system proceeds accordingly. In addition, the asset's owner, via SMS, email or voice, will be notified of the fact that the asset is moving when it should be stationary, and allow the owner to decide what action to take.

The primary option would be to sign onto the database and officially report it as stolen, or to change its status from stolen/lost to ignore, possibly due to an error.

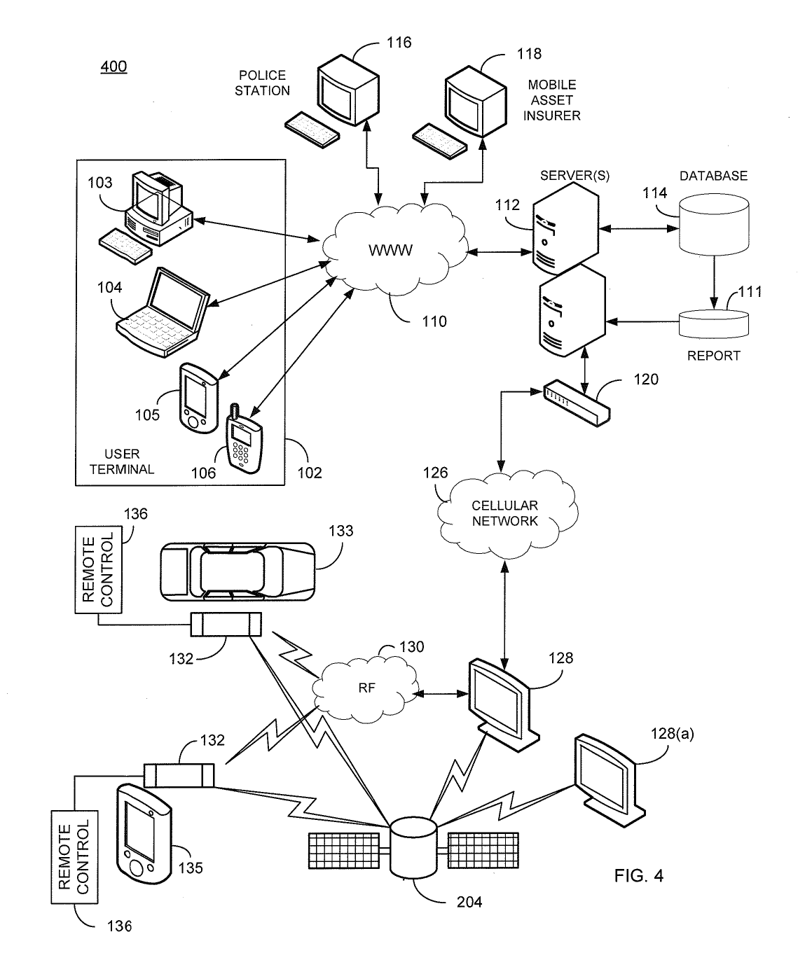

As another alternative FIG. 4 illustrates a system 400 in which the tag and the mobile detection unit are equipped with a GPS modem and a RF modem, for communicating with both an RF network 130 and a GPS satellite 204. If the detection unit 128 comes within the RF range of a mobile asset that has been reported as stolen/lost, then the tag will awaken the GPS modem in the tag, will request the geo-location of the Tag and send the geo location with the tag's serial number to the mobile detection unit 128. This will allow the detection unit 128 to determine the exact position of the moving mobile asset that it is tracking as opposed to using the triangulation method which will provide approximate direction as opposed to exact location.

The main hardware difference is that the tag 132 in the preferred method will only have a RF modem and a disposable battery, in the system 200 of FIG. 2 the tag has a cellular and GPS modem and have a rechargeable battery, and draws more power than the RF Tag 132 in FIG. 1. In the alternative system 400 in FIG. 4 the tag will has an RF modem and a GPS modem with a disposable or a rechargeable battery.

The following description provides additional details of some of the components of the systems:

The RFID tag can include a printed circuit board using a transceiver operating either in the 433 MHz, 915 MHz, or 2.4 GHz spectrum, or some other RF spectrum. The RFID tag can be hidden on the body of the mobile asset or embedded in the mobile asset. Embedded means that technical specifications will be supplied to companies that want the application embedded directly into a printed circuit board of their product. When a consumer purchases a product that has technology embedded in the circuit board, the consumer will then log onto a web site and register the product. In this case a separate tag (132) is not required as the main component parts will be supplied on the printed circuit board of the product purchased. The RFID tag is used to send the serial number of the asset to the detection unit. The RFID tag can include one or more of the following items:

1. Printed circuit board

2. Disposable Battery expected to last approximately 3 years or rechargeable battery

3. Antenna to transmit/receive RFID signals

4. Transceiver (Radio/Modem)

5. Micro Processor, with power amplifier

6. Accelerometer (movement sensor) to track the movement of the RDIF tag, and hence the mobile asset on which the RFID tag is located.

Cellular/GPS Tag—a cellular/GPS tag is a printed circuit board using a micro processor as a modem to access the GPS and a standard cellular bandwidth. The tag can be hidden on the body of the mobile asset or embedded in the mobile asset. The tag is used to send the serial number of the asset and it's location to the central server tracker or to a tracker. The cellular/GPS tag can include one or more of the following items:

1. Printed circuit board

2. Rechargeable Battery

3. Antenna to transmit/receive through a cellular and GPS network

4. Modem to communicate with a cellular and GPS networks.

5. Accelerometer

6. Micro Processor

In some implementations, the RF/GPS tag is a printed circuit board using a transceiver operating in the 433 MHz, 915 MHz, or 2.4 GHz spectrum, or some other RF spectrum. The tag can be hidden on the body of the mobile asset or embedded in the mobile asset. The tag is used to send the serial number and the geo location of the asset to the detection unit. The tag can include one or more of the following items:

1. Printed circuit board

2. Disposable Battery expected to last approximately 3 years or rechargeable battery

3. Antenna's to transmit/receive RF and GPS signals

4. Transceiver (RF/Modem)

5. Micro Processor and power amplifier

6. Accelerometer (movement sensor) to track the movement of the tag, and hence the mobile asset on which the tag is located.

7. GPS modem

Web Based Registration and Reporting System:

Using a web based application, a consumer registers information about the mobile assets the consumer owns and wishes to track. Each user creates a unique customer name and password, wherein the password is a first level of security. Each user registers a RFID tag corresponding to each asset registered. A second level of security, such as a digital signature, can be provided when a user reports a missing item. The digital signature can be used to ensure that the actual owner of the asset is reporting the asset as stolen or missing.

The person using the web application specifies whether the asset is being registered or the asset is being reported as missing. In some implementations, the information comprises the unique RFID number corresponding to the RFID tag attached to the asset, a type of asset or a class of asset (e.g. specification whether the asset is a car or a mobile phone or a child), customer's personal information (e.g. name, date of birth, Social Security Number), name and address of a police station the loss needs to be reported to, make of the asset and color of the asset. An example of the information is as follows:

i. Type of asset (class)

ii. Name and address of police station

iii. Name of insurance company

iv. Vehicle Make and Models

v. Color

vi. Condition—Child, Alzheimer's disease patient etc

vii. Vehicle Type e.g. car, truck, motor cycle

In different exemplary embodiments, one or a combination of the following examples may be used for information that the user of an asset fills in the web application:

Fields Required:

a. Customer Record (for second level of security)
i. Customer Name
ii. Primary Password
iii. Secondary Password
iv. Email address
v. First Name
vi. Middle Name
vii. Last Name
viii. Address line 1
ix. Address line 2
x. City
xi. State/Province
xii. County
xiii. Tel Number
xiv. Cell Number
xv. Date of birth
xvi. Number of messages (email, SMS) sent
xvii. Sent and received messages (email, SMS)

b. Asset Record type I
i. Asset Class=Motor Vehicle
ii. Unique RFID Tag number corresponding to the RFID tag on the asset
iii. VIN number of the vehicle
iv. Registration number of the vehicle
v. State of registration
vi. Main driver of the vehicle
vii. Drivers license number
viii. Expiry Date
ix. Make (2 digit code)
x. Model
xi. Color (2 digit code)
xii. Vehicle Type (2 digit code)
xiii. Year
xiv. Manufacturer (2 digit code)
xv. Purchased New or Used
xvi. Approx Value
xvii. Condition of asset
xviii. Insurance Company—could be blank
xix. Expiry Date of Insurance
xx. Email (or a phone supporting SMS) contact for insurance company
xxi. Date Activated
xxii. Date Reported Stolen
xxiii. Date Recovered
xxiv. Recovered by (Police Department)
xxv. Recovered by (Police Officer)
xxvi. Date Insurance Company notified of theft
xxvii. Date Insurance Company notified of Recovery
xxviii. Impound Location
xxix. Date Impounded

c. Asset Record Type II
i. Asset Class=Electronics
ii. Unique RFID Tag number corresponding to the RFID tag on the asset
iii. Serial number
iv. Make
v. Model
vi. Color
vii. Year
viii. Purchased New or Used
ix. Approximate Value
x. Condition of asset
xi. Insurance Company—could be blank
xii. Expiry Date of Insurance
xiii. Email (or a phone supporting SMS) contact for insurance company
xiv. Date Activated
xv. Date Reported Stolen
xvi. Date Recovered
xvii. Recovered by (Police Department)
xviii. Recovered by (Police Officer)
xix. Date Insurance Company notified of theft
xx. Date Insurance Company notified of Recovery
xxi. Impound Location
xxii. Date Impounded

d. Asset Record Type III
i. Asset Class=Person
ii. Unique RFID Tag number corresponding to the RFID tag on the asset
iii. Condition
iv. Age
v. Male/Female
vi. Color of Hair
vii. Height
viii. Weight
ix. Picture
x. Date Activated
xi. Date Reported Lost/Stolen
xii. Date Recovered
xiii. Comments
xiv. Recovered by (Police Department)
xv. Recovered by (Police Officer)
xvi. xv1 Photograph

An exemplary representation of the information stored in the web application after a loss has been reported is as follows:

Stolen Asset Record:

1. Unique RFID Tag number corresponding to the RFID tag on the asset

2. VIN number

3. License plate number

4. State

5. Date/Time Reported Stolen

6. Reported by name

7. Reported by email address

8. Reported by contact number

9. Identity Number of person reporting the loss

10. Bate of Birth of person reporting the loss

11. Relationship to owner of asset

12. IP address of computer that reported it stolen

In some implementations, any of a number of different languages can be selected for the application.

Packet Data Network:

A packet data network or packet switching can be used with the present system. A packet data network is a digital networking communications method that groups all transmitted data—regardless of content, type, or structure—into suitably-sized blocks, called packets. Packet switching features delivery of variable-bit-rate data streams (sequences of packets) over a shared network. Packets are buffered and queued when being transmitted through network adapters, switches, routers and other network nodes, resulting in variable delay and throughput depending on the traffic load in the network.

The information entered in the application can be encrypted using a private key, and then transmitted across a network (i.e. a packet data network) to the database. The database decrypts the information using a private key. The decrypted information is stored in the database.

Database:

The database can generate messages (e.g. email, SMS) for being sent to the owner of the asset, police, insurance agency, and other partners if required. The message advises the message recipient of how severe the information is, and responsibility the recipient is assuming when making the stolen report. In another embodiment, instead of sending a message to the police and an insurance agency, the owner of the asset is sent a message with steps the owner of the asset needs to take e.g. go to the nearest police station and file a written report, and advise the insurance agency that may have insured against the loss. In another embodiment the owner will be advised that the asset has been recovered as soon as the user of the active detection unit (12) advises the detection unit that the asset is has been recovered. In another implementation the owner will be advised that the asset has been sighted i.e. has come into the range of a detection unit, and will be provided with the address of the detection unit.

Detection Unit:

The detection unit can access information in the database over at least one of a cellular network, satellite network, or other network. The detection unit includes some the following components:

1. Rechargeable battery

2. DC power supply to power the unit

3. USB port to connect to computer in the mobile location like police vehicle.

4. Battery Charger

5. Ear plug Port

6. Speaker

7. Transceiver (RF modem/radio) to allow communications between the RF tag located in or on the asset.

8. Cellular modem/radio to transmit and receive information over either of a cellular or satellite network.

9. GPS radio/modem to obtain the geo location data.

9. Micro Processor

10. Storage Drive

11. RF Antennas to transmit signals to and receive signals from RFID tags.

12. Cellular Antenna to transmit and receive information over either of a cellular network or satellite network

13. GPS antenna to access information for the satellite.

14. Color Touch Screen

Each detection unit/tracker/microcomputer unit has an identification number. Based on the identification number, a particular detection unit/tracker can access certain portion of the information in the database e.g. detection unit covering a particular area may access missing asset requests for the assets lost in that area or in regions close to that area, i.e. a detection unit in a police car roaming in a particular area may access information about thefts in the area the police car covers.

Once an asset is recovered, information of the recovered item can be automatically reported to the owner/guardian of the asset, and to other relevant parties, such as insurance agencies.

Accelerometer—once set by the user or owner of the asset, the movement of the asset is tracked by the motion sensor in the RFID or Cellular tag located on the asset. The movement of the device may also be reported to the owner of the asset. When the tag moves with the accelerometer set, the tag will also send a signal to the remote (136) and the remote will signal the user that the Tag/asset is moving.

Once a lost or stolen asset is picked up by a detection unit 128, the tag can in some cases continually communicate with the detection unit 128, with the intent to allow the detection unit 128 to track the Tag's position as it moves.

Priority Codes—Each class of asset is given a code, those classes with a higher priority will be given preference when reported to the user of the tracker, thus as an example if the detection unit 128 comes into proximity of two stolen or lost assets, the asset with a higher priority will be reported first.

Once an asset is recovered, the user of the detection unit 128 that recovered the asset will report this fact, and the system will update both the central and local databases accordingly. Further, the database may be associated with a server that transmits the relevant data to the detection unit.

The systems described herein can use a cellular network, which is a radio network made up of a number of cells, each served by at least one fixed-location transceiver known as a cell site or base station. When joined together these cells provide radio coverage over a wide geographic area. This enables a large number of portable transceivers (mobile phones, pagers, etc.) to communicate with each other and with fixed transceivers and telephones anywhere in the network, via base stations, even if some of the transceivers are moving through more than one cell during transmission.

Another component of the system is a Radio Frequency Network: Radio spectrum refers to the part of the electromagnetic spectrum corresponding to radio frequencies—that is, frequencies lower than around 300 GHz (or, equivalently, wavelengths longer than about 1 mm).

Different parts of the radio spectrum are used for different radio transmission technologies and applications. Radio spectrum is typically government regulated in developed countries, and in some cases is sold or licensed to operators of private radio transmission systems (for example, cellular telephone operators or broadcast television stations). Ranges of allocated frequencies are often referred to by their provisioned use (for example, cellular spectrum or television spectrum).

The detection unit 128 accesses the information from the database over a cellular network. To optimize efficiency of transmissions of information over either one of a cellular networks, and a radio access network, the server associated with the database should send the information in batches at fixed intervals of time, or on demand. The size of the batches, content of the batches and the fixed intervals of time is controlled by software. The information travelling through any one of the cellular or satellite networks, between the database/server and the detection unit may be encrypted.

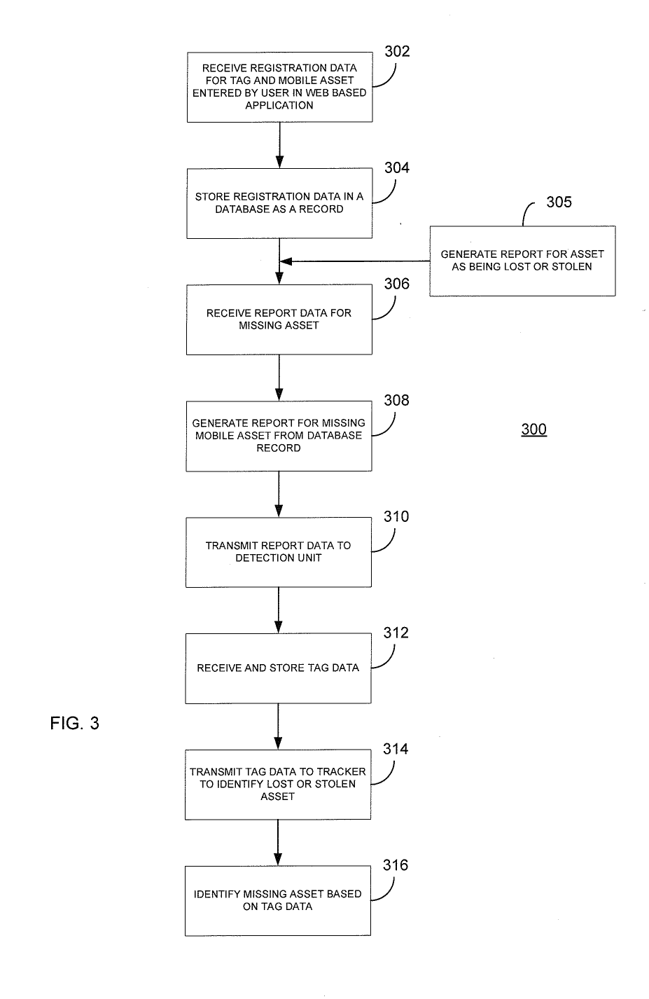

FIG. 3 is a flowchart of a method 300 for securing a mobile asset. At 302, registration data is received. The registration data can include a tag ID and information about the mobile asset related to the tag, and can be received by an application running on a user terminal. At 304, the registration data is stored in a database as a record. The record can be generated according to any relational database protocol, and can be formed for each tag obtained by the user, or for each mobile asset by the user, or both.

If a mobile asset is missing, at 305 a user can enter information at a user terminal (i.e. computer, mobile device, etc.) to make a report of the asset being lost or stolen. At 306 report data for the missing mobile asset, based on the report made by the user of the user terminal, is received. The user supplying the report data can be verified by the application as being the owner of the mobile asset or of having obtained the one or more tags associated with the mobile asset. The report data is used by a server computer at 308 to parse the database to generate a report for the missing mobile asset, based at least in part on the record generated and stored for the mobile asset, as well as other data supplied by the user, such as date, time, and location when the user determined the mobile asset was missing.

At 310 the report is transmitted to, among a number of designated recipients, to a tag locator or detection unit (i.e. tracker). The report can also be transmitted to a mobile computer associated with the detection device, together forming the tag locator. The tags can be configured to periodically and continuously transmit through the an RF network their tag ID, which ID can be detected and received at 312 by the detection unit and matched against the active reports of missing mobile assets. Once the tag ID is received, tag data can be transmitted to a device to determine the general location of the tag associated with the missing mobile asset. At 316, the missing mobile asset can be identified based on the tag data, the location, and at least some of the information in the report, so that a retrieval of the mobile asset is possible.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse, touch screen or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed is:

1. A mobile asset security, tracking and recovery method comprising:
receiving, by one or more processors associated with a database, registration data for the mobile asset, the registration data including at least description data describing the mobile asset and a tag identifier for a radio frequency tag associated with the mobile asset;
storing the registration data in the database;
receiving, by the one or more processors, report data via a communication network indicating the mobile asset is lost or stolen, the report data including at least the description data;
mapping, by the one more processors, the description data and user data to the tag identifier for the radio frequency tag associated with the mobile asset; and
generating, at the one or more processors, a report of the mobile asset being lost or stolen, the report having at least the tag identifier for the radio frequency tag associated with the mobile asset.

2. The mobile asset security, tracking and recovery method in accordance with claim 1, further comprising transmitting the report to a detection unit having a radio frequency signal detector.

3. The mobile asset security, tracking and recovery method in accordance with claim 2, further comprising sensing, by the detection unit, a local area for a radio frequency signal associated with the radio frequency tag to determine a location of the mobile asset within a geographical area.

4. The mobile asset security, tracking and recovery method in accordance with claim 3, wherein the location is determined from global positioning satellite (GPS) data associated with the radio frequency tag.

5. The mobile asset security, tracking and recovery method in accordance with claim 1, wherein the report data is received via a computer network from a user associated with the mobile asset.

6. The mobile asset security, tracking and recovery method in accordance with claim 4, wherein the report data is generated by an application program running on a user terminal according to input from the user.

7. The mobile asset security, tracking and recovery method in accordance with claim 1, wherein the report data further includes user data related to the mobile asset.

8. A mobile asset security, tracking and recovery system comprising:
a user terminal for receiving registration data for the mobile asset, the registration data including at least description data describing the mobile asset and a tag identifier for a radio frequency tag associated with the mobile asset; and
a server that receives the registration data from the user terminal and stores the registration data in a database, the server receiving report data via a communication network indicating the mobile asset is lost or stolen, the report data including at least the description data, the server mapping the description data and user data to the tag identifier for the radio frequency tag associated with the mobile asset, and generating a report of the mobile asset being lost or stolen, the report having at least the tag identifier for the radio frequency tag associated with the mobile asset.

9. The mobile asset security, tracking and recovery system in accordance with claim 8, further comprising at least one detection unit to receive the report of the mobile asset being lost or stolen, the at least one detection unit having a sensor to sense the radio frequency tag associated with the mobile asset.

10. The mobile asset security, tracking and recovery system in accordance with claim 9, wherein the at least one detection unit includes a plurality of detection units within a geographical area.

11. The mobile asset security, tracking and recovery system in accordance with claim 9, wherein sensor of the detection unit senses a local area for a radio frequency signal associated with the radio frequency tag to determine a location of the mobile asset within a geographical area.

12. The mobile asset security, tracking and recovery system in accordance with claim 11, wherein the location is determined from global positioning satellite (GPS) data associated with the radio frequency tag.

13. The mobile asset security, tracking and recovery system in accordance with claim 8, wherein the report data is received via a computer network from a user associated with the mobile asset.

14. The mobile asset security, tracking and recovery system in accordance with claim 13, wherein the report data is generated by an application program running on a user terminal according to input from the user.

15. The mobile asset security, tracking and recovery system in accordance with claim 8, wherein the report data further includes user data related to the mobile asset.

16. A mobile asset security, tracking and recovery system comprising:
one or more radio frequency identification (RFID) tags, each RF tag having an attachment mechanism for attaching to the mobile asset, and having a unique identifier that is continuously transmitted as a radio frequency signal upon activation;
a server system that receives, via a communications network, registration data from a client system, the registration data including at least description data describing the mobile asset and the unique identifier for each RFID tag attached to the mobile asset, the server system further generating a report of the mobile asset being lost or stolen, the report having at least the unique identifier for each RFID tag attached to the mobile asset; and
a detection unit that receives, via the communications network, the report from the server system, the detection unit having an RFID sensor to sense for the radio frequency signal transmitted by activated RFID tags attached to the mobile asset within a geographical range of the radio frequency signal transmission.

17. The mobile asset security, tracking and recovery system in accordance with claim 16, wherein the detection unit further includes a global positioning system (GPS) transceiver for receiving GPS geographic position data.

18. The mobile asset security, tracking and recovery system in accordance with claim 16, wherein the detection unit further includes a computer processor that determines a location and identity of the mobile asset upon sensing the radio frequency signal transmitted by at least one activated RFID tag.
